(19) United States
(12) Patent Application Publication
(10) Pub. No.: US 2023/0017549 A1
(43) Pub. Date: Jan. 19, 2023

(54) INTEGRATED THERMAL MANAGEMENT CIRCUIT FOR A VEHICLE

(71) Applicants: HYUNDAI MOTOR COMPANY, Seoul (KR); KIA CORPORATION, Seoul (KR)

(72) Inventors: Ki Mok Kim, Hwaseong-si (KR); Sang Shin Lee, Suwon-si (KR); Man Ju Oh, Yongin-si (KR); Jae Woong Kim, Hwaseong-si (KR); Uk Il Yang, Yongin-si (KR)

(73) Assignees: HYUNDAI MOTOR COMPANY, Seoul (KR); KIA CORPORATION, Seoul (KR)

(21) Appl. No.: 17/701,461

(22) Filed: Mar. 22, 2022

(30) Foreign Application Priority Data
Jul. 15, 2021 (KR) 10-2021-0092685

(51) Int. Cl. B60H 1/00; B60H 1/03

(52) U.S. Cl. CPC B60H 1/00278; B60H 1/00392; B60H 1/039; B60H 2001/00307

(57) ABSTRACT

An integrated thermal management circuit for a vehicle includes a refrigerant line that causes a refrigerant to flow through a compressor, an interior condenser of an interior air conditioning device, and an exterior condenser outside the vehicle. The circuit causes the refrigerant discharged from the condenser to pass through an integrated chiller or an evaporator of the air conditioning device and to be introduced into the compressor. The circuit includes: a first cooling line causing a cooling water to circulate between a high voltage battery and a first radiator or between the high voltage battery and the integrated chiller; a second cooling line causing the cooling water to circulate between an electronic drive unit and a second radiator or between the electronic drive unit and the integrated chiller; and a bypass line provided in the first cooling line.

### CROSS REFERENCE TO RELATED APPLICATION

The present application claims priority to Korean Patent Application No. 10-2021-0092685 filed on Jul. 15, 2021, the entire contents of which are incorporated herein for all purposes by this reference.

### BACKGROUND

### 1. Field of the Disclosure

The present disclosure relates to an integrated thermal management circuit for a vehicle to achieve a reduction in the number of parts as well as a cost reduction. T

### 2. Description of the Prior Art

Recently, the number of registered eco-friendly vehicles is increasing due to the combination of the policy to expand the supply of eco-friendly vehicles and the preference for high-efficiency vehicles. An electric vehicle, which is a type of eco-friendly vehicle, is a vehicle that is driven by means of an electric battery and an electric motor without using a fossil fuel and an internal combustion engine. A driving system of the electric vehicle in which the motor is driven by electricity accumulated in the battery has several advantages including no emission of harmful substances, low noise, and high energy efficiency.

An existing internal combustion engine vehicle operates an in-vehicle heating system using engine waste heat, whereas an electric vehicle, which has no engine, is systematized to operate a heater with electricity. However, this causes a significant deterioration in the mileage (e.g., the range) of the electric vehicle during heating.

In addition, a battery module needs to be used under an optimal temperature environment to maintain the optimal performance and long lifespan thereof. However, this is practically difficult due to heat generated during driving and an external temperature change.

To solve the problems mentioned above, the organic combination of an air conditioning system and a thermal management system of an electric vehicle is being actively explored.

A conventional thermal management circuit, which uses an integrated chiller for heat exchange with an electronic drive unit and a battery, uses a water heater to increase the temperature of a battery in severe cold weather. The water heater is generally connected in series to the battery on a battery cooling water line, just like the integrated chiller, to heat the cooling water to be introduced into the battery and supply it to the battery. Accordingly, it is impossible to recover the waste heat of the electronic drive unit via the integrated chiller and to utilize the waste heat for vehicle indoor heating while the battery temperature is increasing due to the water heater. This may deteriorate the thermal management efficiency of the vehicle.

The matters described above as the background art are intended merely to assist in understanding the background of the present disclosure. The above description should not be taken as an acknowledgment that the matters described above correspond to the related art already known to those having ordinary skill in the art.

### SUMMARY OF THE DISCLOSURE

In view of the foregoing, there is a need to develop an integrated thermal management circuit capable of implementing various operation modes using one integrated chiller.

The present disclosure has been made in order to solve the above-mentioned problems in the prior art. An aspect of the present disclosure provides an integrated thermal management circuit for a vehicle. The integrated thermal management circuit includes an integrated chiller in which a battery chiller and an electric-device chiller are integrated to achieve a reduction in the number of parts as well as a cost reduction. The integrated chiller is provided on a battery cooling line being bypassed via a bypass line. Thus, for example, heating by a heat pump and an increase in battery temperature may be implemented independently of each other according to the thermal management mode of the vehicle.

In accordance with an aspect of the present disclosure, an integrated thermal management circuit for a vehicle includes a refrigerant line that causes a refrigerant to flow through a number of components in order. These components include a compressor, an interior condenser of an interior air conditioning device, and an exterior condenser outside the vehicle. The refrigerant line then causes the refrigerant discharged from the exterior condenser to pass through an integrated chiller or an evaporator of the interior air conditioning device and thereafter to be introduced into the compressor. The circuit also includes: a first cooling line that causes cooling water to circulate between a high voltage battery and a first radiator or between the high voltage battery and the integrated chiller; a second cooling line that causes the cooling water to circulate between an electronic drive unit and a second radiator or between the electronic drive unit and the integrated chiller;

and a bypass line provided in the first cooling line and configured to cause the cooling water flowing through the first cooling line to bypass the integrated chiller by interconnecting an inlet side and an outlet side of the integrated chiller.

The refrigerant in the refrigerant line is heated by the integrated chiller or the evaporator, may be compressed by the compressor, and may be cooled while passing sequentially through the interior condenser and the exterior condenser.

The first cooling line may be provided with a water heater located at a downstream point of the high voltage battery. The cooling water having passed through the water heater on the first cooling line may pass through the first radiator or the integrated chiller and then be introduced into the high voltage battery, or may bypass the first radiator or the integrated chiller via the bypass line to thereby be introduced into the high voltage battery.

The first cooling line may activate the water heater in a battery temperature rising mode. The cooling water heated by the water heater may bypass the first radiator or the integrated chiller via the bypass line to thereby be introduced into the high voltage battery to raise a temperature of the high voltage battery.

The first cooling line may be provided with a first control valve at a point where the cooling water downstream of the first radiator and downstream of the integrated chiller joins upstream of the high voltage battery. The first control valve may adjust flow of the cooling water to be introduced into the high voltage battery by opening or closing a port on a side of the first radiator or a port on a side of the integrated chiller according to a thermal management mode of the high voltage battery.

The first control valve may be a 3-way valve and may be configured to close the port on the side of the integrated chiller in an outside-air cooling mode of the high voltage battery and to close the port on the side of the first radiator in a chiller cooling mode or a temperature rising mode of the high voltage battery.

The second cooling line may be provided with a second control valve at a point where the cooling water downstream of the second radiator and downstream of the integrated chiller joins upstream of the electronic drive unit. The second control valve may adjust flow of the cooling water to be introduced into the electronic drive unit by opening or closing a port on a side of the second radiator or a port on a side of the integrated chiller according to a thermal management mode of the electronic drive unit.

The second control valve may be a 3-way valve and may be configured to close the port on the side of the integrated chiller in an outside-air cooling mode of the electronic drive unit and to close the port on the side of the second radiator in an electric-device waste-heat recovery mode of the electronic drive unit.

The refrigerant line may be provided with an expansion valve at an upstream point of the exterior condenser, at an upstream point of the integrated chiller, or at an upstream point of the evaporator. The refrigerant passing through the expansion valve at the upstream point of the exterior condenser, at the upstream point of the integrated chiller, or at the upstream point of the evaporator may selectively expand according to a heating/cooling mode of the vehicle.

When the first cooling line implements a battery temperature rising mode via the bypass line, the second cooling line may implement an electric-device waste-heat recovery mode of the electronic drive unit and the refrigerant line may implement indoor heating using waste heat of the electronic drive unit.

An expansion valve may be provided at the upstream point of the integrated chiller. The refrigerant circulating in the refrigerant line may sequentially undergo compression by the compressor, condensation by the interior condenser, expansion by the expansion valve at the upstream point of the integrated chiller, and evaporation by the integrated chiller to implement indoor heating using waste heat of the electronic drive unit.

The refrigerant line may be provided with a frosting line. The frosting line may be configured to cause the refrigerant flowing through the refrigerant line to bypass the exterior condenser when frosting occurs in the exterior condenser by interconnecting an inlet side and an outlet side of the exterior condenser.

According to an integrated thermal management circuit for a vehicle of the present disclosure, an integrated chiller in which a battery chiller and an electric-device chiller are integrated is provided to achieve a reduction in the number of parts as well as a cost reduction. The integrated chiller is provided on a battery cooling line being bypassed via a bypass line so that, for example, heating by a heat pump and increasing battery temperature may be implemented independently of each other according to the thermal management mode of the vehicle.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 is a diagram illustrating an integrated thermal management circuit for a vehicle according to an embodiment of the present disclosure;

FIG. 2 is a diagram illustrating the integrated thermal management circuit for the vehicle according to an embodiment of the present disclosure, in which an electric-device waste-heat recovery mode, an interior heating mode, and a battery temperature increasing mode are respectively implemented;

FIG. 3 is a diagram illustrating the integrated thermal management circuit for the vehicle according to an embodiment of the present disclosure, in which an outside-air and electric-device waste-heat recovery mode, an interior heating mode, and a battery temperature increasing mode are respectively implemented; and

FIG. 4 is a diagram illustrating the integrated thermal management circuit for the vehicle according to an embodiment of the present disclosure, to which a frosting line is added.

### DETAILED DESCRIPTION OF THE EMBODIMENTS

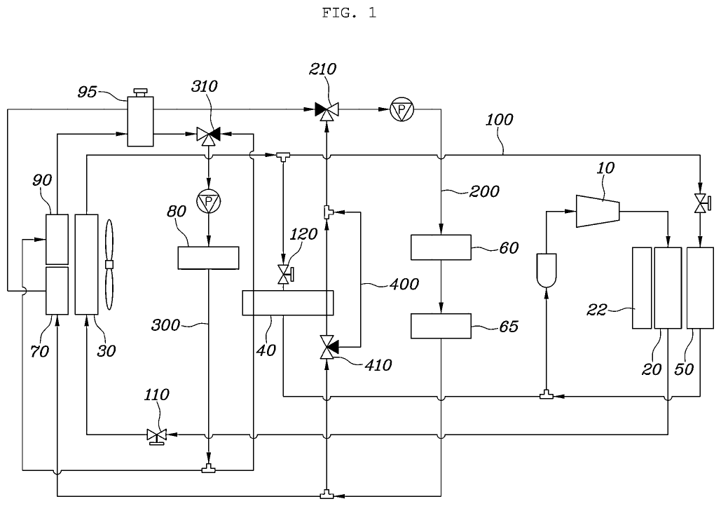

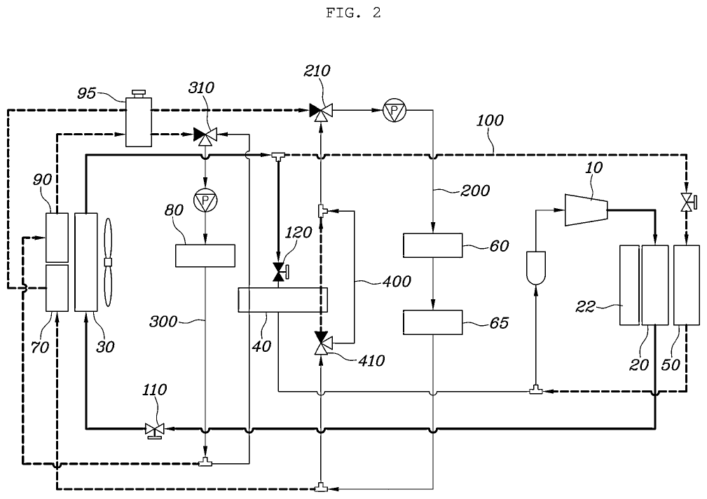

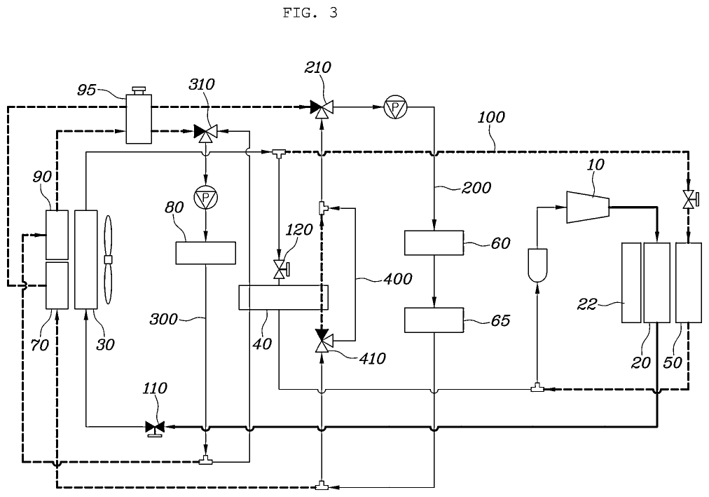

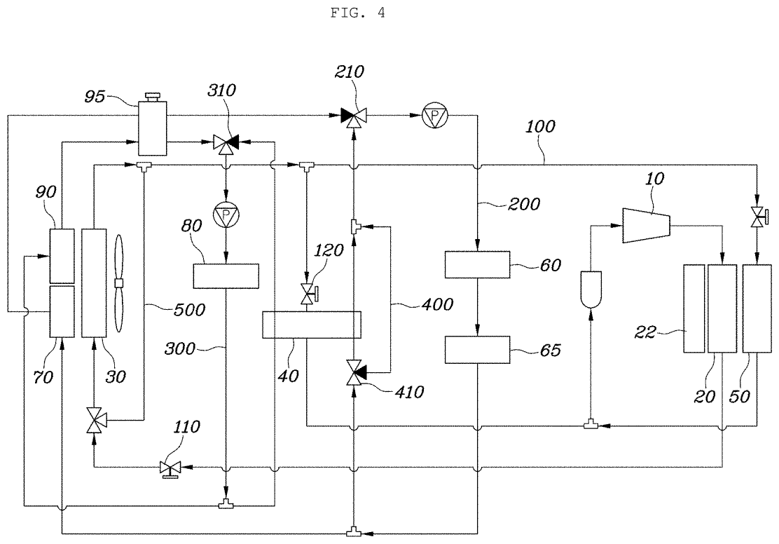

FIG. 1 is a diagram illustrating an integrated thermal management circuit for a vehicle according to an embodiment of the present disclosure. FIG. 2 is a diagram illustrating the integrated thermal management circuit for the vehicle according to an embodiment of the present disclosure, in which an electric-device waste-heat recovery mode, an interior heating mode, and a battery temperature increasing mode are respectively implemented. FIG. 3 is a diagram illustrating the integrated thermal management circuit for the vehicle according to an embodiment of the present disclosure, in which an outside-air and electric-device waste-heat recovery mode, an interior heating mode, and a battery temperature increasing mode are respectively implemented. FIG. 4 is a diagram illustrating the integrated thermal management circuit for the vehicle according to an embodiment of the present disclosure, to which a frosting line is added. When a component, device, element, or the like of the present disclosure is described as having a purpose or performing an operation, function, or the like, the component, device, or element should be considered herein as being “configured to” meet that purpose or to perform that operation or function.

FIG. 1 is a diagram illustrating an integrated thermal management circuit for a vehicle according to an embodiment of the present disclosure. The integrated thermal management circuit for the vehicle according to an embodiment of the present disclosure includes a refrigerant line 100, which causes a refrigerant to flow in the order of a compressor 10, an interior condenser 20 of an interior air conditioning device, and an exterior condenser 30 outside the vehicle. The refrigerant line then causes the refrigerant discharged from the exterior condenser 30 to pass through an integrated chiller 40 or an evaporator 50 of the interior air conditioning device and thereafter to be introduced into the compressor 10. The circuit further includes a first cooling line 200, which causes a cooling water to circulate between a high voltage battery 60 and a first radiator 70 or between the high voltage battery 60 and the integrated chiller 40. The circuit includes a second cooling line 300, which causes the cooling water to circulate between an electronic drive unit 80 and a second radiator 90 or between the electronic drive unit 80 and the integrated chiller 40 The circuit includes a bypass line 400, which is provided on the first cooling line 200 and causes the cooling water flowing through the first cooling line 200 to bypass the integrated chiller 40 by interconnecting the inlet side and the outlet side of the integrated chiller 40.

In addition, in the integrated thermal management circuit for the vehicle according to an embodiment of the present disclosure, the refrigerant in the refrigerant line 100, may be heated by the integrated chiller 40 or the evaporator 50, may be compressed by the compressor 10, and may be cooled while passing sequentially through the interior condenser 20 and the exterior condenser 30.

When a conventional thermal management circuit using an integrated chiller implements a battery temperature increase by a water heater 65, heating by a heat pump using the waste heat of an electronic drive unit 85 cannot be implemented. In this case, interior heating must depend on a PTC heater 22, which has a very low efficiency.

In view of this, the integrated thermal management circuit for the vehicle according to an embodiment of the present disclosure controls a 3-way valve 410, which interconnects the front and rear ends of the integrated chiller 40 and which is provided at the front end of the integrated chiller 40. The circuit allows the cooling water in the first cooling line 200 to be heated by the water heater 65 and bypass the integrated chiller 40. A battery temperature increase is thereby implemented and at the same time may independently implement heating by a heat pump using the waste heat of the electronic drive unit 80 via heat exchange between the cooling water of the second cooling line 300 and the refrigerant of the refrigerant line 100 in the integrated chiller 40.

FIG. 2 is a diagram illustrating the integrated thermal management circuit for the vehicle according to an embodiment of the present disclosure, in which an electric-device waste-heat recovery mode, an interior heating mode, and a battery temperature increasing mode are respectively implemented. FIG. 3 is a diagram illustrating the integrated thermal management circuit for the vehicle according to an embodiment of the present disclosure, in which an outside-air and electric-device waste-heat recovery mode, an interior heating mode, and a battery temperature increasing mode are respectively implemented. The first cooling line 200 of the integrated thermal management circuit for the vehicle according to an embodiment of the present disclosure may be provided with the water heater 65 located at a downstream point of the high voltage battery 60. The cooling water having passed through the water heater 65 on the first cooling line 200 may pass through the first radiator 70 or the integrated chiller 40 and then may be introduced into the high voltage battery 60, or may bypass the first radiator 70 or the integrated chiller 40 via the bypass line 400 to thereby be introduced into the high voltage battery 60.

Specifically, in the integrated thermal management circuit for the vehicle according to an embodiment of the present disclosure, the first cooling line 200 may activate the water heater 65 in the battery temperature increasing mode. The cooling water heated by the water heater 65 may bypass the first radiator 70 or the integrated chiller 40 via the bypass line 400 to thereby be introduced into the high voltage battery 60 to raise the temperature of the high voltage battery 60.

In addition, the first cooling line 200 of the integrated thermal management circuit for the vehicle according to an embodiment of the present disclosure is provided with a first control valve 210 at the point where the cooling water downstream of the first radiator 70 and downstream of the integrated chiller 40 joins upstream of the high voltage battery 60. The first control valve 210 is capable of adjusting the flow of cooling water to be introduced into the high voltage battery 60 by opening or closing a port on the side of the first radiator 70 or a port on the side of the integrated chiller 40 according to the thermal management mode of the high voltage battery 60.

Specifically, in the integrated thermal management circuit for the vehicle according to an embodiment of the present disclosure, the first control valve 210 is a 3-way valve. The first control valve 210 is capable of closing the port on the side of the integrated chiller 40 in the outside-air cooling mode of the high voltage battery 60 and is also capable of closing the port on the side of the first radiator 70 in the chiller cooling mode or the temperature rising mode of the high voltage battery 60.

In addition, the second cooling line 300 of the integrated thermal management circuit for the vehicle according to an embodiment of the present disclosure is provided with a second control valve 310 at the point where the cooling water downstream of the second radiator 90 and downstream of the integrated chiller 40 joins upstream of the electronic drive unit 80. The second control valve 310 is capable of adjusting the flow of cooling water to be introduced into the electronic drive unit 80 by opening or closing a port on the side of the second radiator 90 or a port on the side of the integrated chiller 40 according to the thermal management mode of the electronic drive unit 80.

Specifically, in the integrated thermal management circuit for the vehicle according to an embodiment of the present disclosure, the second control valve 310 is a 3-way valve. The second control valve 310 is capable of closing the port on the side of the integrated chiller 40 in the outside-air cooling mode of the electronic drive unit 80 and is also capable of closing the port on the side of the second radiator 90 in the electric-device waste-heat recovery mode of the electronic drive unit 80.

In addition, the refrigerant line 100 of the integrated thermal management circuit for the vehicle according to an embodiment of the present disclosure is provided with an expansion valve at an upstream point of the exterior condenser 30, at an upstream point of the integrated chiller 40, or at an upstream point of the evaporator 50. As such, the refrigerant passing through the expansion valve at the upstream point of the exterior condenser 30, at the upstream point of the integrated chiller 40, or at the upstream point of the evaporator 50 may selectively expand according to the heating/cooling mode of the vehicle.

In the integrated thermal management circuit for the vehicle according to an embodiment of the present disclosure, when the first cooling line 200 implements the battery temperature rising mode via the bypass line 400, the second cooling line 300 may implement the electric-device waste-heat recovery mode of the electronic drive unit 80. The refrigerant line 100 may implement interior heating using the waste heat of the electronic drive unit 80.

Specifically, in the integrated thermal management circuit for the vehicle according to an embodiment of the present disclosure, the expansion valve is provided at the upstream point of the integrated chiller 40. The refrigerant circulating in the refrigerant line 100 sequentially undergoes compression by the compressor 10, condensation by the interior condenser 20, expansion by the expansion valve at the upstream point of the integrated chiller 40, and evaporation by the integrated chiller 40, to implement indoor heating using the waste heat of the electronic drive unit 80.

In conclusion, with the control of the first control valve 210 and the second control valve 310 provided downstream of the single integrated chiller 40, various operation modes such as electric-device outside-air cooling, electric-device waste-heat recovery, battery outside-air cooling, battery chiller cooling, and dehumidification modes may be independently implemented. These modes may be implemented in addition to the battery temperature increasing mode and the heat pump indoor heating mode. Thus, the thermal management efficiency of the vehicle may be enhanced.

FIG. 4 is a diagram illustrating the integrated thermal management circuit for the vehicle according to an embodiment of the present disclosure, to which a frosting line is added. The refrigerant line 100 of the integrated thermal management circuit for the vehicle according to an embodiment of the present disclosure may be provided with a frosting line 500, which causes the refrigerant flowing through the refrigerant line 100 to bypass the exterior condenser 30 when frosting occurs in the exterior condenser 30 by interconnecting the inlet side and the outlet side of the exterior condenser 30. When frosting occurs in the exterior condenser 30, the refrigerant flows to the frosting line 500, so that no refrigerant is introduced into the exterior condenser 30. The refrigerant may expand in any of an expansion valve 110 provided at the front end of the exterior condenser 30 and an expansion valve 120 provided at the front end of the integrated chiller 40 on the refrigerant line 100 as needed. Various thermal management modes may be effectively implemented even if frosting occurs in the exterior condenser 30.

It should be apparent to those having ordinary skill in the art that, although the specific embodiments of the present disclosure have been illustrated and described, various modifications and variations of the present disclosure can be made without departing from the technical spirit of the present disclosure provided by the following claims.

What is claimed is:

1. An integrated thermal management circuit for a vehicle, the circuit comprising:
a refrigerant line that causes a refrigerant to flow in an order of a compressor, an interior condenser of an interior air conditioning device, and an exterior condenser outside the vehicle and then causes the refrigerant discharged from the exterior condenser to pass through an integrated chiller or an evaporator of the interior air conditioning device and thereafter to be introduced into the compressor;
a first cooling line that causes a cooling water to circulate between a high voltage battery and a first radiator or between the high voltage battery and the integrated chiller;
a second cooling line that causes the cooling water to circulate between an electronic drive unit and a second radiator or between the electronic drive unit and the integrated chiller; and
a bypass line provided in the first cooling line and configured to cause the cooling water flowing through the first cooling line to bypass the integrated chiller by interconnecting an inlet side and an outlet side of the integrated chiller.

2. The circuit according to claim 1, wherein the refrigerant in the refrigerant line, heated by the integrated chiller or the evaporator, is compressed by the compressor and is cooled while passing sequentially through the interior condenser and the exterior condenser.

3. The circuit according to claim 1, wherein the first cooling line is provided with a water heater at a downstream point of the high voltage battery, and wherein the cooling water having passed through the water heater on the first cooling line passes through the first radiator or the integrated chiller and is then introduced into the high voltage battery, or bypasses the first radiator or the integrated chiller via the bypass line to thereby be introduced into the high voltage battery.

4. The circuit according to claim 3, wherein the first cooling line activates the water heater in a battery temperature rising mode, and wherein the cooling water heated by the water heater bypasses the first radiator or the integrated chiller via the bypass line to thereby be introduced into the high voltage battery to raise a temperature of the high voltage battery.

5. The circuit according to claim 1, wherein the first cooling line is provided with a first control valve at a point where the cooling water downstream of the first radiator and downstream of the integrated chiller joins upstream of the high voltage battery, and wherein the first control valve adjusts flow of the cooling water to be introduced into the high voltage battery by opening or closing a port on a side of the first radiator or a port on a side of the integrated chiller according to a thermal management mode of the high voltage battery.

6. The circuit according to claim 5, wherein the first control valve is a 3-way valve and is configured to close the port on the side of the integrated chiller in an outside-air cooling mode of the high voltage battery and to close the port on the side of the first radiator in a chiller cooling mode or a temperature rising mode of the high voltage battery.

7. The circuit according to claim 1, wherein the second cooling line is provided with a second control valve at a point where the cooling water downstream of the second radiator and downstream of the integrated chiller joins upstream of the electronic drive unit, and wherein the second control valve adjusts flow of the cooling water to be introduced into the electronic drive unit by opening or closing a port on a side of the second radiator or a port on a side of the integrated chiller according to a thermal management mode of the electronic drive unit.

8. The circuit according to claim 7, wherein the second control valve is a 3-way valve and is configured to close the port on the side of the integrated chiller in an outside-air cooling mode of the electronic drive unit and to close the port on the side of the second radiator in an electric-device waste-heat recovery mode of the electronic drive unit.

9. The circuit according to claim 1, wherein the refrigerant line is provided with an expansion valve at an upstream point of the exterior condenser, at an upstream point of the integrated chiller, or at an upstream point of the evaporator, and wherein the refrigerant passing through the expansion valve at the upstream point of the exterior condenser, at the upstream point of the integrated chiller, or at the upstream point of the evaporator selectively expands according to a heating/cooling mode of the vehicle.

10. The circuit according to claim 1, wherein, when the first cooling line implements a battery temperature rising mode via the bypass line, the second cooling line implements an electric-device waste-heat recovery mode of the electronic drive unit and the refrigerant line implements indoor heating using waste heat of the electronic drive unit.

11. The circuit according to claim 10, wherein an expansion valve is provided at the upstream point of the integrated chiller, and wherein the refrigerant circulating in the refrigerant line sequentially undergoes compression by the compressor, condensation by the interior condenser, expansion by the expansion valve at the upstream point of the integrated chiller, and evaporation by the integrated chiller to implement indoor heating using waste heat of the electronic drive unit.

12. The circuit according to claim 1, wherein the refrigerant line is provided with a frosting line, and wherein the frosting line is configured to cause the refrigerant flowing through the refrigerant line to bypass the exterior condenser when frosting occurs in the exterior condenser by interconnecting an inlet side and an outlet side of the exterior condenser.
